(19) United States
(12) Patent Application Publication
(10) Pub. No.: US 2014/0067500 A1
(43) Pub. Date: Mar. 6, 2014

(54) EVENT OUTCOMES PREDICTION SYSTEMS AND METHODS

(71) Applicants: Christopher Robb Heineman, Kansas City, MO (US); Asim Pasha, Liberty, MO (US); James Flexman, Leawood, KS (US)

(72) Inventors: Christopher Robb Heineman, Kansas City, MO (US); Asim Pasha, Liberty, MO (US); James Flexman, Leawood, KS (US)

(21) Appl. No.: 13/596,552

(22) Filed: Aug. 28, 2012

(51) Int. Cl. G06Q 30/02

(52) U.S. Cl. 705/14.17; 705/14.1

(57) ABSTRACT

A system and method is provided that enables users to selectively predict one or more outcomes expected to occur during an upcoming event, such as a sporting event. A graphical user interface enables users to specify data for individual outcomes predicted to occur during the event. Rewards and/or an amount of the rewards are determined for predictions based on a comparison of actual outcomes with the predicted outcomes and/or one or more business rules. Users obtain rewards for accurate outcome predictions in near-real time during live events and can view reward amounts and/or actual game statistics during the live event.

### RELATED APPLICATIONS

Not Applicable.

### FEDERALLY SPONSORED RESEARCH OR DEVELOPMENT

Not Applicable.

### COMPACT DISK APPENDIX

Not Applicable.

### BACKGROUND

Sport enthusiasts often attempt to showcase their knowledge about a particular sport or sporting event by predicting the overall outcome of that particular sporting event or by predicting one or more individual outcomes, such as scores, that will occur during the sporting event. Conventional gaming systems exist that allow a more knowledgeable participant to win a game by correctly predicting the outcome of one or more sporting events during a season. Such gaming methods can be either fantasy methods or outcome-based methods.

Fantasy based methods involve the creation of teams and utilization of in-game statistics for the selected players to create a score and is associated with a particular type of sport or event. An example of this type of game is a Fantasy Football game which may be operated online by a service provider that allows users to log in and access their servers to play the game entirely online and in a remote manner.

Outcome-based methods involve predictions of the outcomes of real sporting contests, and a player is rewarded for making the most correct predictions. Some methods call for predicting the outright winners of contests, some call for predicting teams to cover point spreads published for contests and yet other methods call for predicting contest scores. The players with the highest aggregate number of correct picks over a given timeframe, such as a week or an entire tournament season, will win.

Unfortunately, such conventional systems do not enable to participants to easily and quickly predict multiple aspects of one or more individual outcomes during an event. Such systems also do not communicate information regarding predictions to participants in near-real time.

### SUMMARY

According to one aspect, a system is provided for predicting at least one outcome of an event. The system includes at least one processor and an application that includes modules that are executable by the at least one processor. A graphical user interface module transmits a graphical user interface for the display. The graphical user interface is configured to receive one or more inputs defining predicted micro-outcome data for a particular event. The predicted micro-outcome data includes a particular player identity associated with a particular micro-outcome during the particular event, a particular location within a venue for the particular micro-outcome; and a particular time during the particular event the particular micro-outcome occurs. The graphical user interface also generates a prediction request comprising the predicted micro-outcome data.

A prediction processing module receives the prediction request and retrieves actual micro-outcome data from an actual outcome data source. A reward calculation module calculates a reward amount based on a comparison of the actual micro-outcome data with the predicted micro-outcome data included in the prediction request.

According to another aspect, a system is provided for predicting at least one outcome of an event. The system includes cat least one processor and a memory storing venue data for a plurality of events. The venue data comprises a graphical view of a venue for each of the plurality of events. The system also includes a prediction application with modules that are executable by the at least one processor.

A graphical user interface module transmits a graphical user interface for display. The graphical user interface displays a list of events and receives a first input corresponding to a selection of a particular event from the list of events. The graphical user interface is also displays a list of outcome types for the particular event selected and receives a second input corresponding to a selection of a particular outcome type from the list of outcome types. The graphical user interface also displays corresponding venue data for the particular event selected, displays a first plurality of tokens associated with a first team competing in the particular event, and displays a second plurality of tokens associated with a second team competing in the particular event. The graphical user interface also receives at least one third input each comprising position data for a particular one of the tokens selected from the first plurality of tokens and the second plurality of tokens. The position data indicates a particular location on the graphical view for an occurrence of the particular outcome type. The graphical user interface further displays a list of eligible player identities based on the position data for the particular token receives a fourth input corresponding to a particular player identity predicted to be involved with the selected outcome type. The graphical user interface also generates a prediction request comprising predicted outcome data, the predicted outcome data comprising the particular player identity and the particular location for the particular outcome type.

A prediction processing module receives the prediction request and retrieves actual outcome data from an actual outcome data source. The actual outcome data includes at least an actual player identification and an actual location for each actual outcome type occurring during the particular even. A reward calculation module calculates a reward amount based on a comparison of the actual outcome data with the predicted outcome data included in the prediction request.

According to another aspect, a method is provided for predicting at least one outcome of an event. The method includes receiving a prediction request comprising predicted micro-outcome data at at least one processor. The predicted micro-outcome data comprising a particular player identity associated with a particular micro-outcome during a particular event, a particular location within a venue for the particular micro-outcome; and a particular time during the particular event the particular micro-outcome occurs.

The method also includes retrieving actual micro-outcome data from an actual outcome data source for the particular event and calculating, at the at least one processor, an reward amount based on a comparison of the actual micro-outcome data with the predicted micro-outcome data included in the prediction request. The method also includes transferring the reward amount to an account associated with a particular user associated with the prediction request.

According to yet another aspect, a method is provided for predicting at least one outcome of an event. The method includes storing venue data for a plurality of events in a memory. The venue data includes a graphical view of a venue for each of the plurality of events. The method also includes transmitting a graphical user interface for the display at a remote computing device.

The graphical user interface displays a list of events and receives a first input corresponding to a selection of a particular event from the list of events. The graphical user interface also display a list of outcome types for the particular event selected and receives a second input corresponding to a selection of a particular outcome type from the list of outcome types. The graphical user interface also displays corresponding venue data for the particular event selected, displays a first plurality of tokens associated with a first team competing in the particular event, and displays a second plurality of tokens associated with a second team competing in the particular event. The graphical user interface further receives at least one third input each comprising position data for a particular one of the tokens selected from the first plurality of tokens and the second plurality of tokens. The position data indicates a particular location on the graphical view for an occurrence of the particular outcome type. The graphical user interface also displays a list of eligible player identities based on the position data for the particular token and receives a fourth input corresponding to a particular player identity predicted to be involved with the selected outcome type.

The method also includes receiving a prediction request generated at a processor in response to one or more inputs received at the graphical user interface. The prediction request includes predicted outcome data and the predicted outcome data includes the particular player identity and the particular location for the particular outcome type. The method also includes retrieving actual outcome data from an actual outcome data source. The actual outcome data comprising an actual player identification and an actual location for each actual outcome type occurring during the particular even. The method further includes calculating a reward amount at the processor based on a comparison of the actual outcome data with the predicted outcome data included in the prediction request.

### BRIEF DESCRIPTION OF THE DRAWINGS

FIG. 1A is a block diagram of a computing environment that includes an event prediction system.

FIG. 1B depicts an exemplary embodiment of a client computer according to one aspect of the event prediction system.

FIG. 1C depicts an exemplary embodiment of a data source according to an aspect of the event prediction system.

FIG. 2 is a block diagram of a computing device configured with an event prediction application according to one aspect of the event prediction system.

FIGS. 3A-3H are screen shots of data entry forms according to aspects of the event prediction system.

FIG. 4 is a process flow depicting a method for generating a prediction request according to an aspect of the event prediction system.

FIG. 5 is a process flow depicting a method for calculating a reward amount according to an aspect of the event prediction system.

### DETAILED DESCRIPTION

Aspects of the event prediction system described herein enable users to selectively predict one or more outcomes that will occur during a live event, such as a sporting event. The sporting event is, for example, a football game, a soccer match, a basketball game, or any other event where opposing players compete to achieve a winning outcome. Such sporting events may take place on a field, court, course, track, table, or other venue.

According to one aspect, the event prediction system provides a graphical user interface that enables users to selectively identify a scoring player, a location of the scoring player, a time the score will occur, and/or other predictive outcome data. The event prediction system further determines whether a user qualifies for a reward and/or an amount of the reward based on a comparison of actual outcomes with the predicted outcomes and/or one or more business rules.

Other aspects of the event prediction system enable users to interact with the graphical user interface to view randomly generated outcomes. The event prediction system enables a user to select one or more of the randomly generated outcomes and determines whether the user qualifies for a bonus reward amount based on comparison of actual outcome data and the selected one or more randomly generated outcomes.

Other aspects of the event prediction system enable users to selectively toggle between a monetized wagering mode and non-monetized mode. In the monetized wagering mode, users wage real money against other users based on a comparison of their predicted outcomes with actual outcomes. In the non-monetized mode, a user obtains points based on the accuracy that user's predicted outcomes. In the non-monetized reward or point mode, a the user can also wager rewards or points against other users.

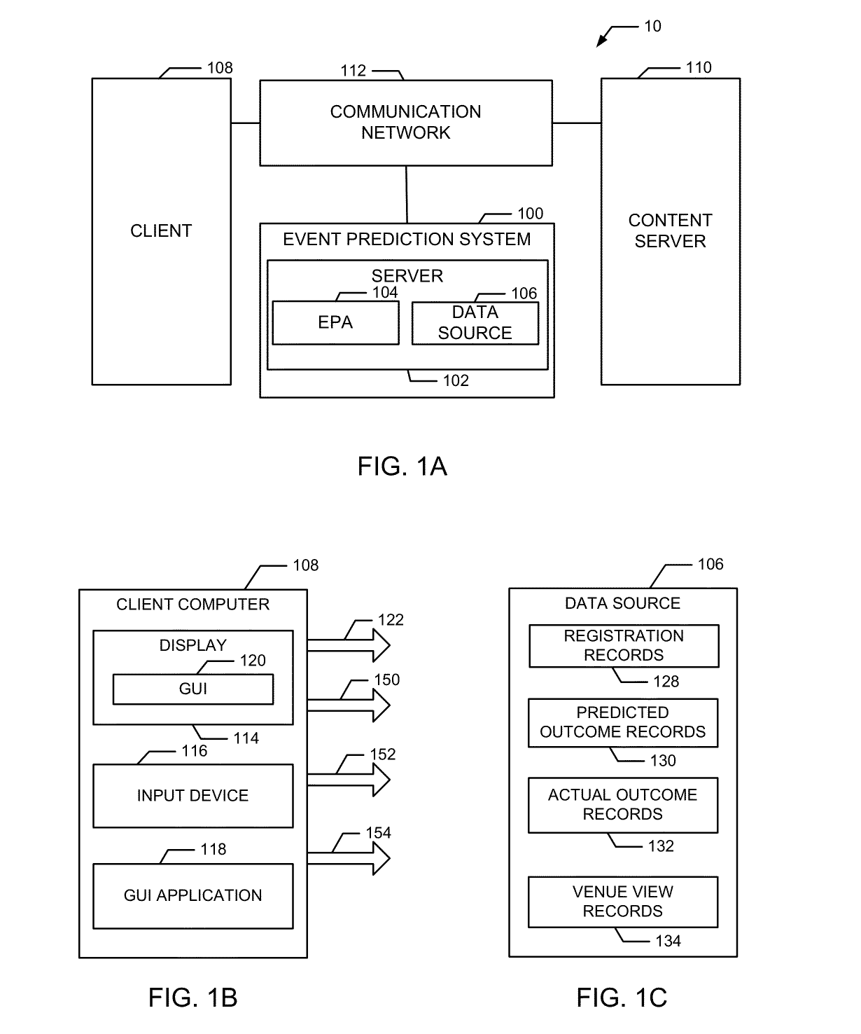

FIG. 1A is a block diagram of an exemplary computing environment 10 that includes an event prediction system (EPS) 100 in accordance with aspects of the invention. The EPS 100 includes a server computing device (server) 102 that includes an event prediction application (EPA) 104 and a data source 106. The EPS 100 communicates with one or more client computing devices (client) 108 and statistical content servers (e.g., servers) 110 via a communication network 112. Although the data source 106 is shown as being located on, at, or within the server 102, it is contemplated that the data source 106 can be located remotely from the server 102 in other aspects of the EPS 100. For example, the data source 106 can be located on, at, or within a database of another computing device or system having at least one processor and volatile and/or non-volatile memory.

The server 102 is a computer or computing device that includes one or more processors and memory and executes the EPA 104 to identify predicted outcomes that are eligible for rewards or other incentive, and to calculate a reward amount or other incentive type for predicted outcomes. Examples of a local server 102 include one or more servers, personal computers, mobile computers, and other computing devices. The local server 102 is configured to communicate via wireless and/or wireline communications.

The server 102 receives data and/or communications from and/or transmits data and/or communications to the client 108 through the communication network 112. The server 102 also receives data and/or communications from and/or transmits data and/or communications to one or more content server 110 through the communication network 112.

The client 108 includes one or more processors and volatile and/or non-volatile memory. Examples of a remote client 108 include one or more personal computers, mobile computers and/or other mobile devices, and other computing devices. The client 108 communicates via wireless and/or wireline communication.

The content server 110 transmits statistics and/or actual outcome data for one or more live events to the server 102 in real-time or near real-time. Outcome data includes micro-outcome data and macro-outcome data. As used herein, a macro-outcome refers to the overall outcome of a particular game or sporting event (e.g., who wins and who loses and/or final scores). A micro-outcome includes any type of action that occurs during a game that can influence the overall outcome (i.e., macro-outcome) of the game, such as a score, penalty, injury, etc.

As a specific an example, the content server 110 may be configured to transmit in real-time or near real-time actual micro-outcome data, such as player identities associated with micro-outcomes, field locations (e.g., coordinates) of micro-outcomes, and occurrence times of micro-outcomes from soccer matches throughout the world. In this example, micro-outcomes include passes, shots, goals, cards, headers, duels, and/or other specific micro-outcomes that may occur during a soccer match.

The communication network 112 can be can be the Internet, an intranet, and/or another wired and/or wireless communication network. In one aspect, the server 102, the client 108, and/or the content server 110 communicate data in packets, messages, or other communications using a protocol, such as a Hypertext Transfer Protocol (HTTP) or a Wireless Application Protocol (WAP). Other examples of communication protocols exist.

FIG. 1B depicts an exemplary embodiment of the client 108 according to one aspect of the EPS 100. The client 108 is a computing or processing device that includes one or more processors and memory and is configured to receive data and/or communications from and/or transmit data and/or communications to the server 102 via the communication network 112. For example, the client 108 can be a laptop computer, a personal digital assistant, a tablet computer, standard personal computer, or another processing device. The client 108 includes a display 114, such as a computer monitor, for displaying data and/or graphical user interfaces. The client 108 may also include an input device 116, such as a keyboard or a pointing device (e.g., a mouse, trackball, pen, or touch screen) to enter data into or interact with graphical user interfaces.

Each client 108 may also include a graphical user interface (or GUI) application 118, such as a browser application, to generate a graphical user interface 120 on the display 114. The graphical user interface 120 enables a user of the client 108 to view actual outcome data, statistical data, field views, and other data for one or more live events and/or previous events. The graphical user interface 120 also enables a user of the client 108 to view and modify predicted outcome data previously submitted by the user to the server.

According to another aspect, the graphical user interface 120 enables a user of the client 108 to interact with various data entry forms to enter authentication data an/or submit predicted outcome data regarding one or more outcomes that the user expects to occur during a particular game.

In operation, the server 102 executes the EPA 104 in response to an access request 122 from the client 108. The access request 122 is generated, for example, by the user entering a uniform resource locator (URL) that corresponds to the location of the EPA 104 on the server 102 via the graphical user interface 120 at the client 108. Thereafter, the user can utilize the input device 116 to interact with an authentication data entry form to submit an authentication request 150 to the EPS 100 and gain access to the prediction service.

An authenticated or otherwise authorized user can utilize the input device 116 to interact with an event prediction management form received from the server 102 to generate a prediction request 152 that is transmitted to the EPS 100. The prediction request 152 includes outcome data for one or more outcomes the user predicts will occur during a particular event. The outcome data may include macro-outcome data and/or micro-outcome data. For example, the prediction request 152 may include the location data, player identification data, and time data associated with a particular micro-outcome.

In other aspects, as explained in more detail below, after the prediction request 152 is transmitted to the EPS 100 and before the event begins, the user can interact with the event prediction management form to generate a modified prediction request 154 that is transmitted to the EPS 100. For example, the modified prediction request 154 may include modified or new location data, modified or new player identification data, and modified or new time data.

FIG. 1C depicts an exemplary embodiment of a data source 106 according to one aspect of the EPS 100. The data source 106 can be a local database or can be another server (not shown) that communicates with the server 102 via the communication network 212. According to one aspect, the data source 106 stores registration records 128, predicted outcome records 130, actual outcome records 132, and venue view records 134. Although the EPS 100 is depicted as including a single data source 106, it is contemplated that the EPS 100 may include multiple data sources in other aspects.

Each user registration record 128 includes registration data for users authorized to use the EPS 100. Example registration data may include the name of the user or a business representative, an account number assigned by the EPS 100, an email address, a phone number, a mailing address, and other contact information for the user. The registration data may also include user account information, such as account settings (e.g., settings related to group games, settings related to social contacts, etc.), authentication information (e.g., user identification code and/or a password), preferences (e.g., player preferences regarding video feeds, preferred sporting events), player profile data (e.g., user name, screen name, etc.), and other information for a player's account (e.g., financial information, account identification numbers, virtual assets, etc.).

Each predicted outcome record 130 includes information regarding the predicted outcome data. Predicted outcome data includes micro-outcome data and/or macro-outcome data received from a particular user. As used herein, micro-outcome data includes location data, player identification data, and time data associated with a particular identified outcome (e.g., a particular score) during an event. The predicted outcome record 130 may also include both historical and current micro-outcome data and/or macro-outcome data. Each actual outcome record 132 includes information regarding actual micro-outcome data and/or macro-outcome data for particular event.

Each venue view record 134 includes venue data for particular event. For example, the venue data includes graphical information such as a depiction of a venue, such as a field, course, table, court, track, etc. upon which the particular event takes place. The geographic information identifies a shape, boundaries, scoring region, and other graphical information of the venue for the particular event.

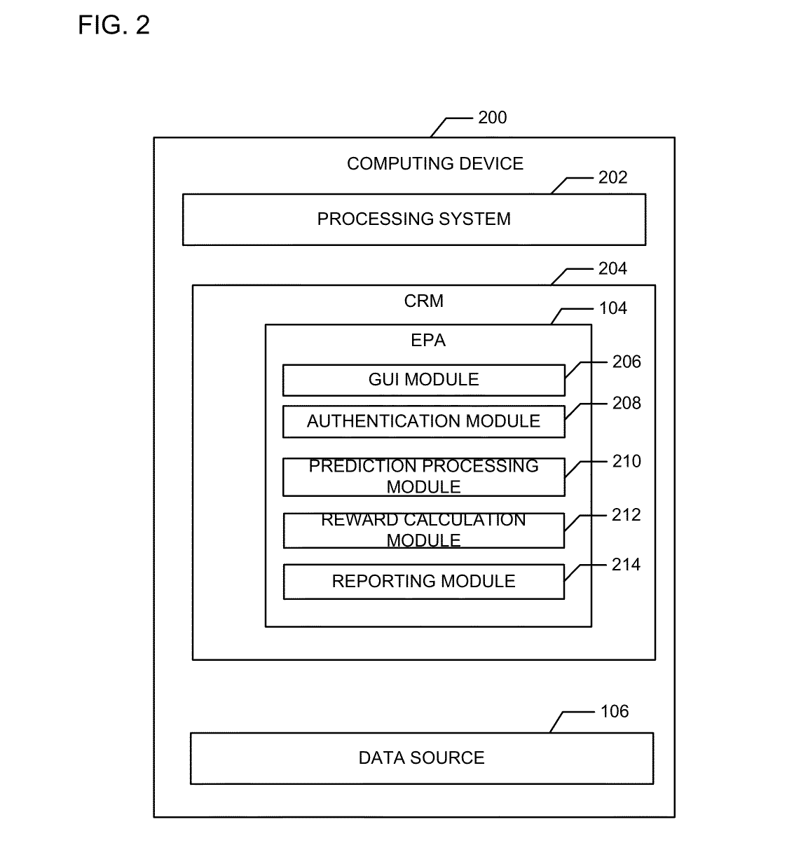

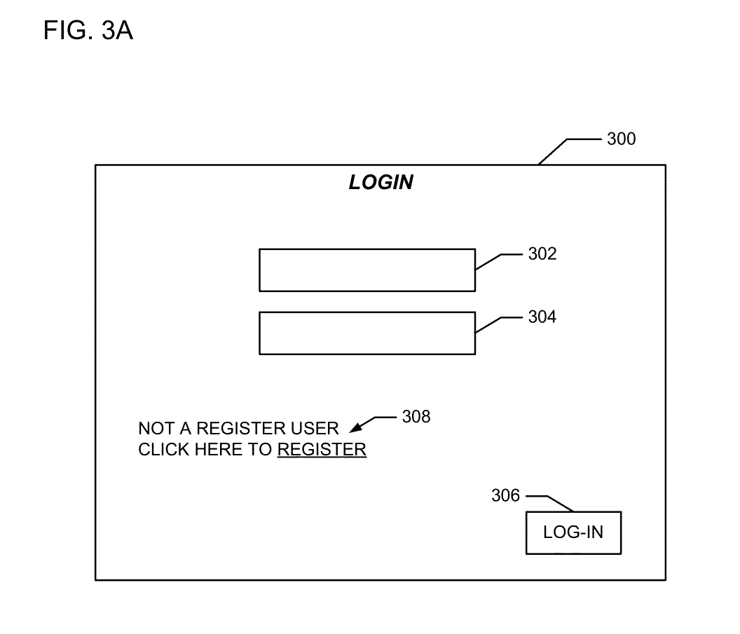

FIG. 2 is a block diagram depicting an exemplary EPA 104 executing on a computing device 200 (e.g., server 102). According to one aspect, the computing device 200 includes a processing system 302 that includes one or more processors or other processing devices. The processing system 202 executes the EPA 104 to process predicted outcome data included in a received prediction request 152 to determine if one or more predicted micro-outcomes and/or predicted macro-outcomes are eligible for a reward and, if eligible, a value for the award.

According to one aspect, the computing device 200 includes a computer readable medium (“CRM”) 204 configured with the EPA 104. The EPA 104 includes instructions or modules that are executable by the processing system 202 to determine if one or more predicted micro-outcomes and/or predicted macro-outcomes are eligible for a reward and, if eligible, a value for the award.

The CRM 204 may include volatile media, nonvolatile media, removable media, non-removable media, and/or another available medium that can be accessed by the computing device 200. By way of example and not limitation, the CRM 204 comprises computer storage media and communication media. Computer storage media includes nontransient memory, volatile media, nonvolatile media, removable media, and/or non-removable media implemented in a method or technology for storage of information, such as computer readable instructions, data structures, program modules, or other data. Communication media may embody computer readable instructions, data structures, program modules, or other data and include an information delivery media or system

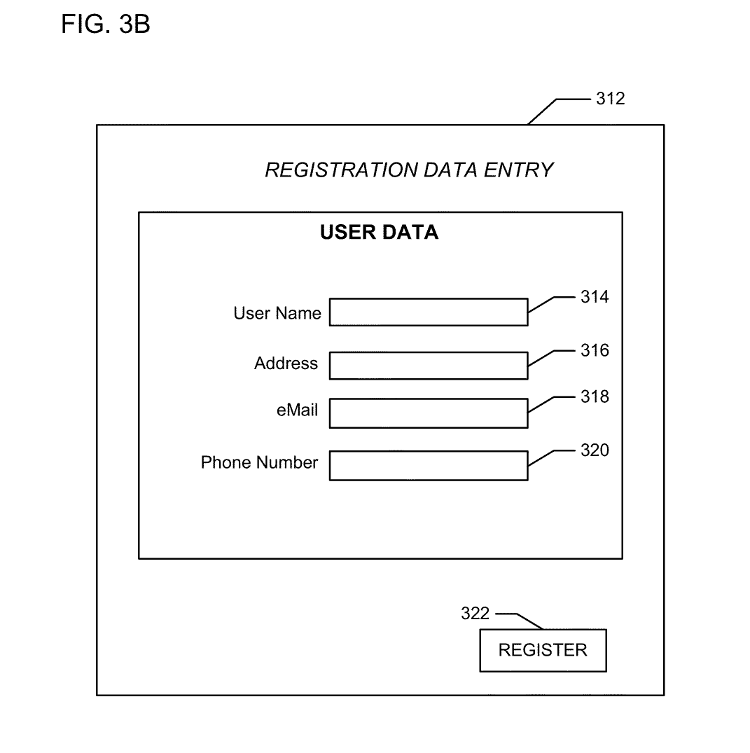

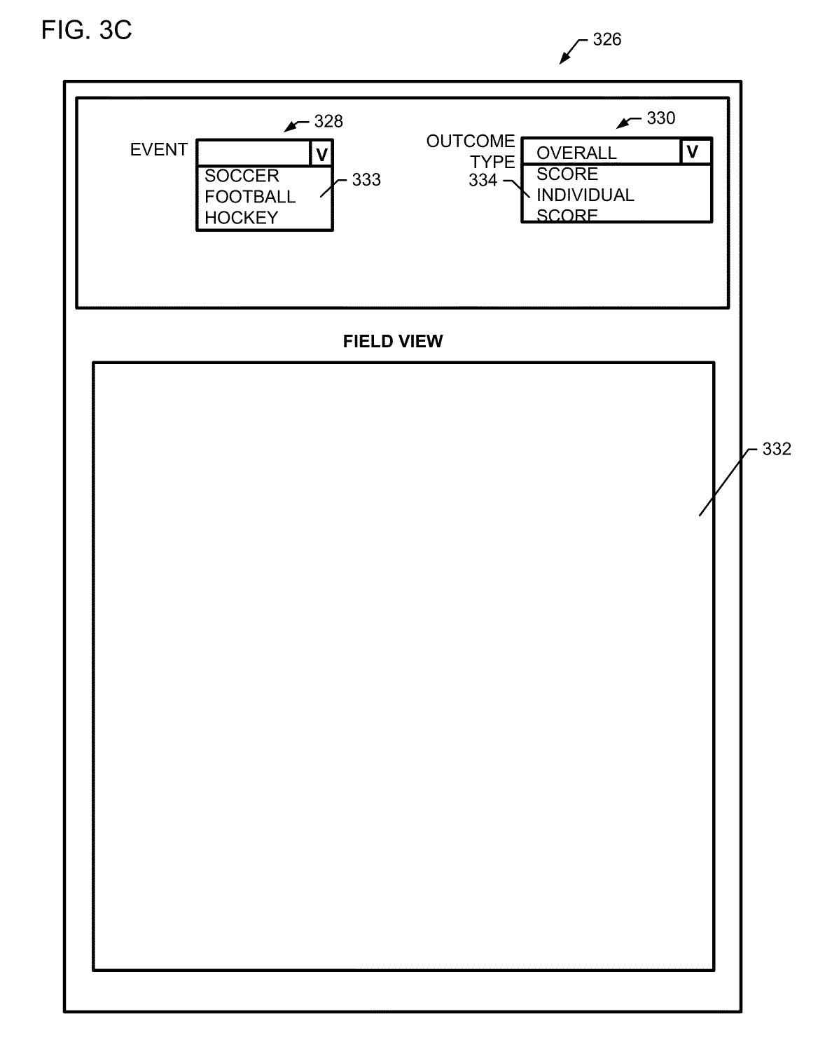

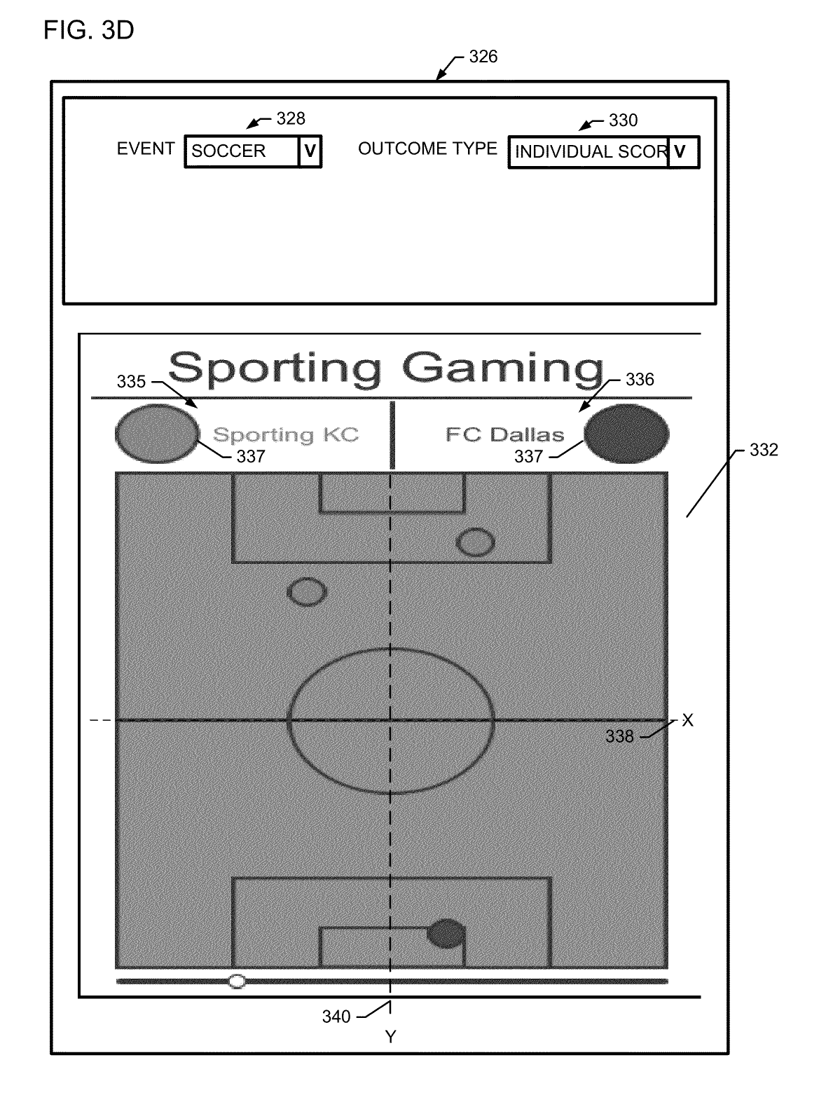

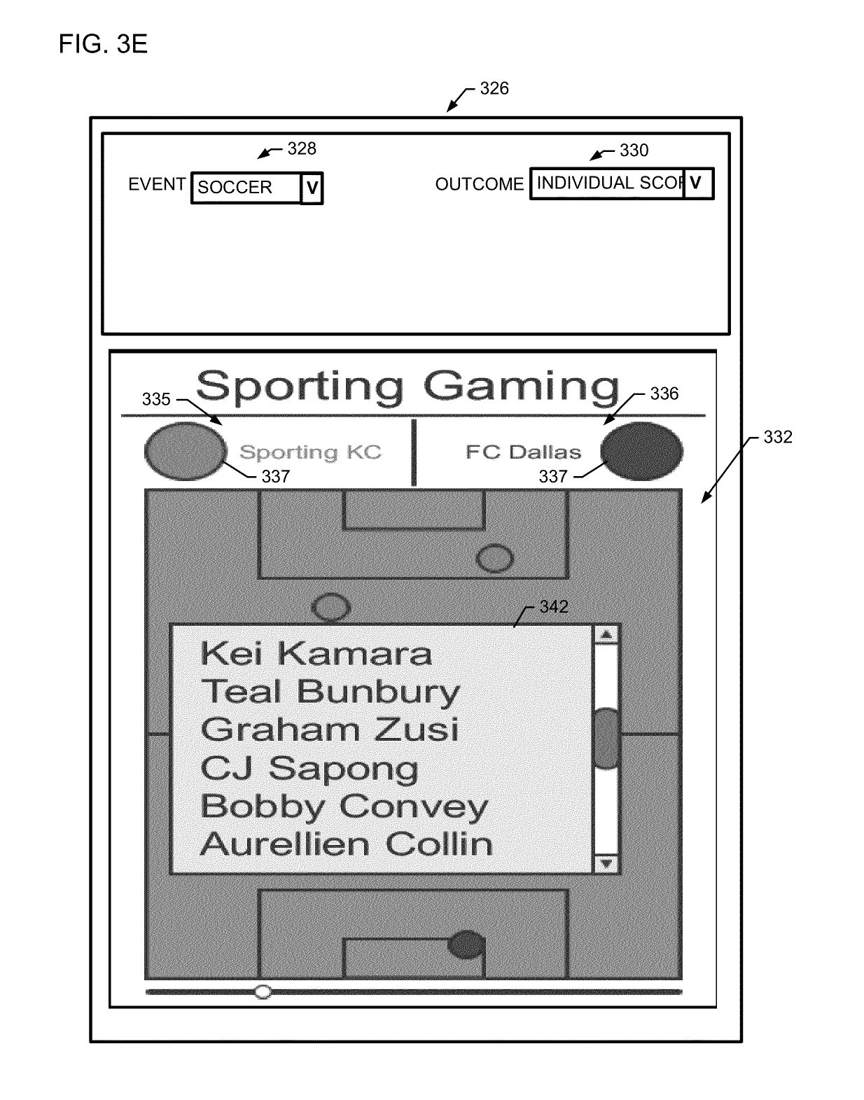

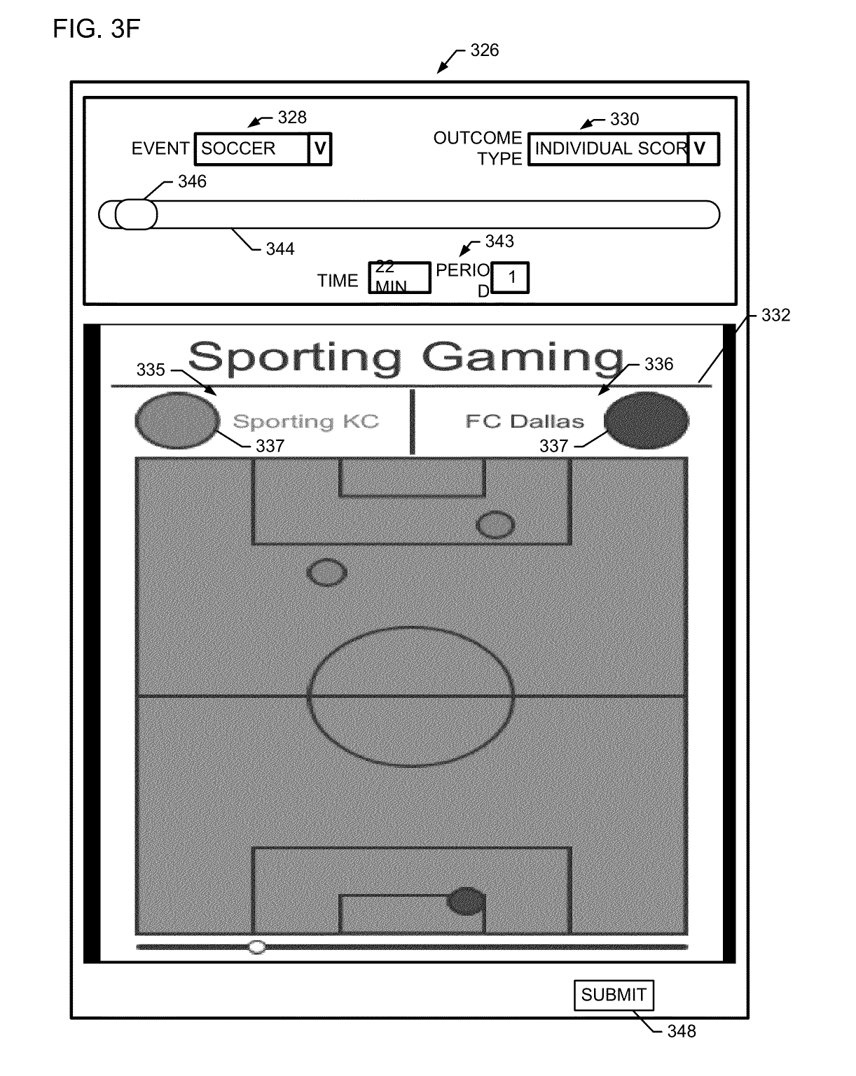

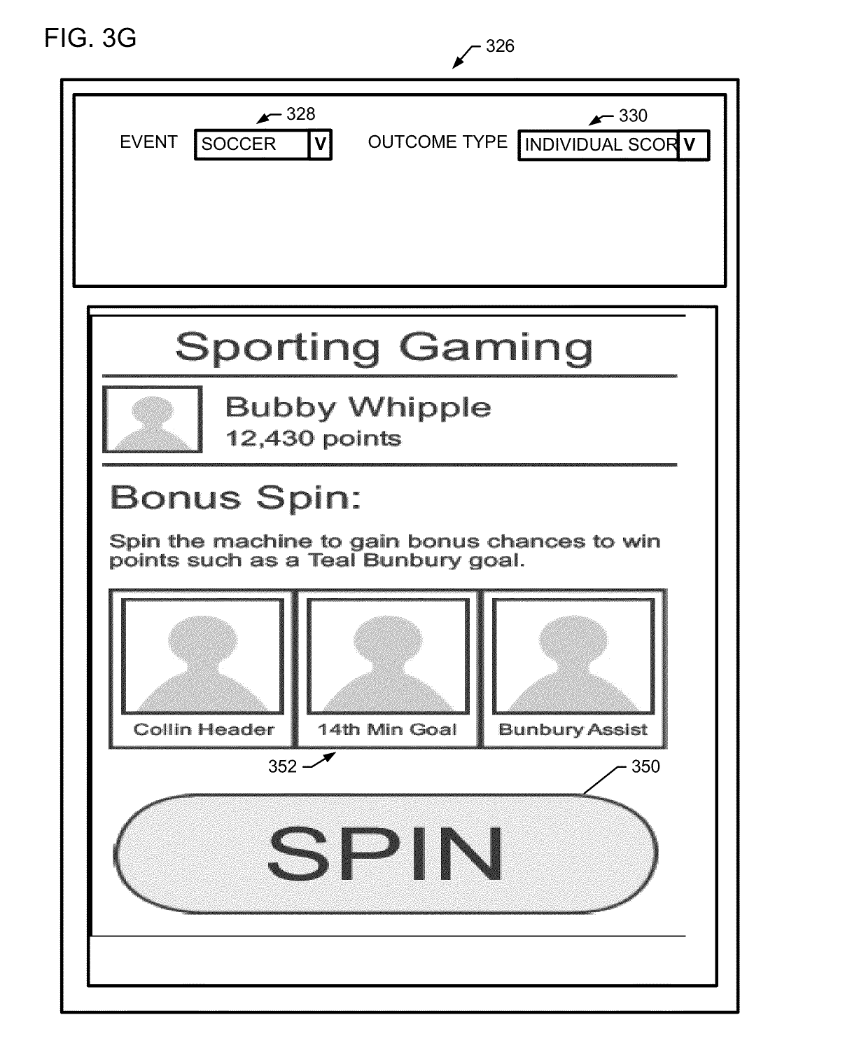

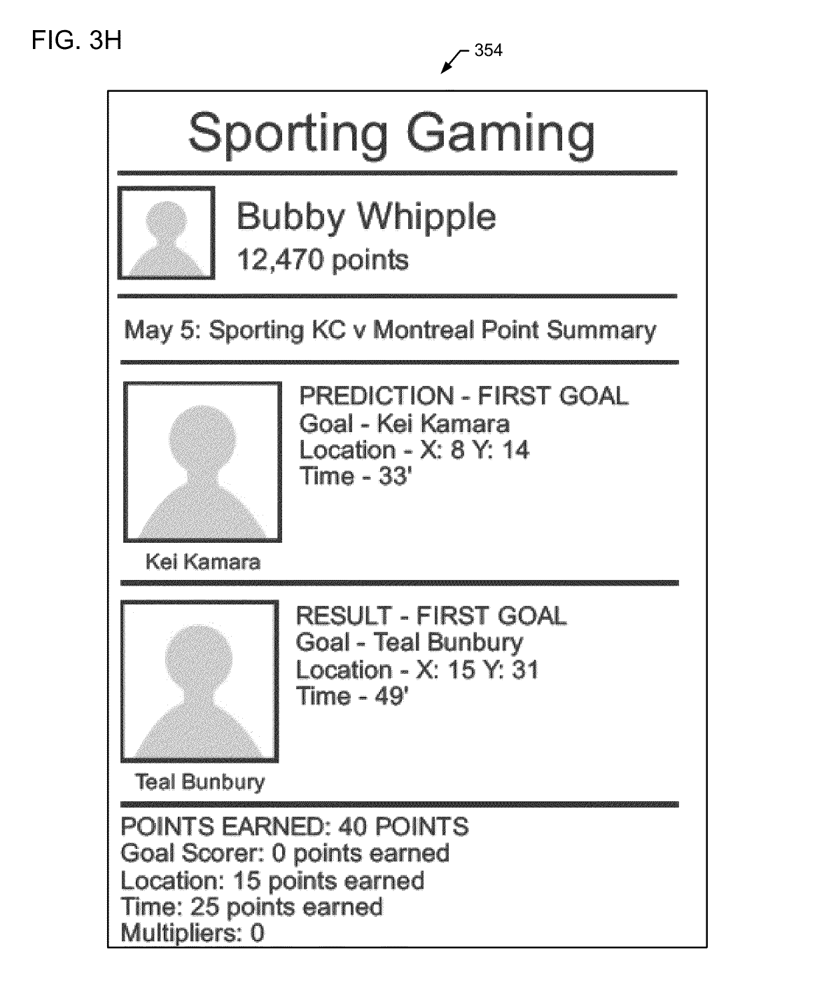

A GUI module 206 transmits a login form to the client 108 after the EPA 104 receives an access request (e.g., access request 122) from the client 108. The user of the client 108 can interact with the login form to view a registration form and/or an outcome prediction management form. FIGS. 3A, 3B, and 3C depict exemplary screen shots of a log-in form, a registration form, and the outcome prediction management form, respectfully, transferred to the remote device 108 by the GUI module 306.

FIG. 3A depicts an exemplary login form 300 according to one aspect of the EPS 100. The login forms 300 is, for example an HTML document, such as a web page that includes an user identification (user id) input field 302 for entering a user id and a password input field 304 for entering a password. After the user enters the user id and password and selects a log-in control 306, an authentication request (e.g., authentication request 150) is generated that includes the user id and password and is sent to the EPS 100.

The login form 300 may include an option control that allows users to become registered users of the EPS 100. For example, if the user has not previously elected to register with the EPS 100, the user can register with the EPS 100 by selecting a register option 308 and by supplying biographical information (e.g., name, address, e-mail, etc.), user authentication data (e.g., user id and password), and other user profile information.

If the user is registered with the EPS 100 and enters valid authentication data (user id and a password input), the outcome prediction management form is transmitted to the client 108 for display. If the authentication request does not include valid authentication data, the authentication module 208 sends a notification to the client 108 that authentication data is invalid and the user is not logged-in to the EPS 100. The login form 300 depicted in FIG. 3A is meant to be non-limiting. Other examples of login forms exist.

FIG. 3B depicts an exemplary registration form 312 that enables the user to enter registration data to register with the EPS 100. The registration forms 312 is, for example, an HTML document, such as a web page that includes a name field 314, address field 316, an e-mail field 318, and a phone number field 320. The name field 314 enables the user to enter the name of the user requesting access to the event prediction service. The address field 316 enables the user to enter a mailing and/or billing address. The e-mail address field 318 enables the user to enter an e-mail. The phone number field 320 enables the user to enter a telephone number. After the user enters advertiser data and selects registration control 322, a registration request is generated that includes, for example, name, advertiser address, e-mail, phone number, payment information and is sent to the EPS 100. The registration form 312 depicted in FIG. 3B is meant to be non-limiting. Other examples of registration forms exist.

Referring back to FIG. 2, an authentication module 208 determines if a user has provided valid authentication data, such as a correct user id and/or password via an authentication request received from the client 108. If the authentication request includes valid authentication data, the authentication module 208 designates the user as being an authorized user and logs the user into the EPS 100. The GUI module 206 retrieves registration data from the data source 106 that corresponds to the received authentication data. As described above, registration data includes, for example, account number information, account balance information (number of available points and/or a monetary value). The GUI module 206 then transmits the event prediction management form to the client 108 for display.

FIG. 3C depicts an exemplary event prediction management form 326 that enables the user to enter predicted outcome data for one or more events, such as sporting events. In this example, the event prediction management form 326 includes event identification fields 328, outcome identification fields 330, and a venue view window 332.

The event identification field 328 enables a user to enter event data, such as a particular event for which the user would like to predict one or more outcomes. According to one aspect, the event identification field 328 includes an events list box 333 that enables the user to browse various events that are scheduled to occur in the future and to select a particular event. For example, the user interacts with the list box 333 via scroll bars, touch screen, scroll ball, etc, to navigate through a list of future events to select an upcoming soccer match.

The outcome identification field 330 enables the user to outcome identification data, such as an outcome type, for the selected event. According to one aspect, the outcome identification field 330 includes an outcome list box 334 that enables the user to browse through various outcomes types and to select a particular outcome type predicted to occur during the selected event. For example, the user interacts with the list box 334 via scroll bars, touch screen, scroll ball, etc, to navigate through a list of outcomes to select overall score outcome type for the event (i.e., macro-outcome), an individual score outcome type during the selected event (i.e., micro-outcome), or another outcome type.

Referring back to FIG. 2, the GUI module 206 retrieves venue data from the data source 106 for display in the venue window 332 of the event prediction management form 326, such as shown in FIG. 3D. The retrieved venue data corresponds to a graphical view of the venue for the selected event. For example, as described above, venue data includes graphical information or a wire frame that depicts a field, course, table, court, track, or other venue type upon which the selected event takes place. The geographic information identifies a shape, boundaries, scoring region, and other graphical information regarding the venue for the particular event. In this particular example, the venue view window 332 displays a view of a soccer field.

The event prediction management form 326 also includes token selection portions 335, 336. The token selection portion 335 corresponds to a particular team (e.g., Sporting KC) and token selection portion 336 corresponds to a particular opposing team (e.g., FC Dallas). Each of the token selection portions 335, 336 includes tokens 337 that can be selectively positioned on the venue view to specify location data within the venue that a particular outcome is predicted to occur.

For example, the venue is overlaid on a coordinate system that includes an X-axis and a Y-axis, as indicated by reference characters 338, 340, respectively. A user designates an X, Y coordinate location for particular outcome by placing or locating a token 337 at the location on the venue where the user predicts the particular outcome will occur. Tokens 337 can be selected, dragged, and dropped from either of the two token selection portions 335, 336. For example, the user can select a token from token selection portion 335 and release (e.g., via a drag and drop operation) the token at the location on the venue a goal is predicted to occur. Although, the event prediction management form 326 only depicts two token portions 335, 336, it is contemplated that other embodiments may have additional token portions that correspond to three or more teams. such as coordinates along an X and Y axis.

The GUI module 206 generates a player list box 342, such as shown in FIG. 3E that enables the user to browse through a list of players of a particular team that corresponds to the particular token selection portion 335, 336 from which the token 337 was selected. The user interacts with the list box 338 to select a particular one of players predicted to be involved in the selected outcome type at the designated location. For example, when the user releases or drops a selected token at the designated location, the GUI module 206 displays the player list box 342 that allows the user to select a particular player he or she predicts to score a goal. The user interacts with the player list box 342 by using, for example, via scroll bars, touch screen, scroll ball, etc, to navigate through a list of players to select the particular player (e.g., Kei Kamara).

The GUI module 206 displays a time entry data field 343, such as shown in FIG. 3F, in response to the selected outcome type, the designated location, and the indentified player. The time data entry fields may be a text boxes in which the user can manually enter time data, such as a specific time, or a specific span of time during the event that designated event will occur at the designated location. A specific time may correspond to a specific number of minutes into the event For example, if the event is soccer, the user interacts with the time data entry field to enter or select the time and/or an event period the goal will be scored (e.g., 22 minutes into the first period). A specific time span may be a time range, such within 22 to 25 minutes into the event.

Alternatively, the time data may be automatically entered into the time entry data field 343 via a time control. For example, the GUI module 206 displays a time bar 344 via the event management form 326, such as shown in FIG. 3F. The time bar 344 enables a user to select a particular time and/or time period the selected event is predicted to occur by sliding or positioning a time control 346 at a desired position along the time bar 344. Other examples of time controls exist.

After the user enters event identification data, outcome identification data, location data, player identification data, and time data into the event management form, the user selects for example, a “submit” control 348, to generate a prediction request (e.g., prediction request 152). The prediction request includes the event identification data, outcome identification data, location data, player identification data, and time data and is sent to the EPS 100.

According to another aspect, a user can modify predicted outcome data prior to the start of the event. For example, the user can interact with the event prediction management form 326 to change location data by repositioning the location of one or more tokens by, for example, dragging and dropping each the one or more tokens to a new the location on the field where they think a goal will occur. Users can also delete any of their chips by touching and dragging to the end of the screen. In a similar manner as described above, the user can also interact with the event prediction management form 326 to modify or change player identification data and time data.

After the user enters new, location data, player identification data, and time data into the event management form, the user selects for example, the “submit” control 348, to generate a modified prediction request (modified prediction request 154). The modified prediction request includes the event identification data, outcome identification data, the new location data, new player identification data, and new time data and is sent to the EPS 100.

The GUI module 206 displays a bonus control 350, such as shown in FIG. 3G, in response to user selecting the submit control 348. By selecting the bonus control 350, the user will be able to spin a slot-like mechanism to view various randomized outcomes in bonus view window 352. In example shown in FIG. 3G, various randomized outcomes displayed in the bonus view window include 14th minute goal, Teal Bunbury goal, Collin Header, Bunbury assist. If any of the random outcomes occur, the user will earn an additional reward amount (i.e., bonus amount).

A prediction processing module 210 receives the prediction request (and/or the modified prediction request) from the remote computing device (e.g., the client 108). The prediction processing module 210 identifies predicted micro-outcome data and/or macro-outcome data included in the received prediction request. For example, the prediction processing module 210 processes the prediction request to determine one or more micro-outcomes, such as location data, player identification data, and time data associated with a particular micro-outcome and to determine macro-outcome data, such as a final score and/or final player statistics.

The prediction processing module 210 may determine macro-outcome data, such as a final score, by summing micro-outcome data for each of the particular outcome types being predicted (e.g., summing all the individual scores). The prediction processing module 210 then optionally stores the micro-outcome data and/or macro-outcome data in the data source 106.

The prediction processing module 210 receives actual statistical data for the selected event from a remote server (e.g., content server 110) in near-real time. The remote server is, for example, operated by statistics content service or provider that tracks and provides statistics data feeds for various sporting events throughout the world. In addition to providing actual macro-outcome data, such as actual final scores, for various events, the remote server also provides actual micro-outcome data, such as actual player identities, actual X, Y coordinates and actual times (to the second) for the various events.

A reward calculation module 212 calculates a reward amount to award the user based on the accuracy of the user's predictions. According to one aspect, the reward amount is a number of points. The points are, for example, interactive points that can be redeemed for items of no or little monetary value such, as free access to web services, digital goods, etc.

According to another aspect, the reward amount is a monetary amount. The reward calculation module 212 further initiates the transfer of monetary amount to an account assigned to the user by the EPS 100 during a registration process. Alternatively, the reward calculation module 212 initiates the transfer of the monetary amount to a user personal banking account identified from user registration data stored in the data source 106.

According to one aspect, the reward type (i.e., points or money) depends on the region and/or country in which the EPS 100 is providing the prediction service. For example, an EPS 100 operating in Europe can be configured to award users actual money and to allow users to place monetary wagers against other users. In contrast, an EPS 100 operating in the United States may only be configured to award points to users based and/or allow users to wager points against other users.

According to another aspect, the EPS 100 is configured to enable users to toggle between point rewards and monetary rewards. For example the event prediction form includes a points reward control (not shown) and monetary award control (not shown) that enable a user to elect to receive points or money, respectively.

For each predicted micro-outcome (e.g., individual score), the reward calculation module 212 calculates a reward amount to award that particular prediction based on the accuracy of the corresponding micro-outcome data. In this example, the micro-outcome data includes values for at least three predicted micro-outcome variables, such as the predicted identity of player that scored the goal (P), the predicted location (e.g., X, Y coordinates) of scored goal, and the predicted time (T) of the match that the goal was scored. The reward calculation module 212 then compares the predicted variable values for the micro-outcome with corresponding actual statistical data (i.e., values of actual micro-outcome variables) received from the remote content server to determine the accuracy of the predicted variables. In other words, the reward amount awarded for each predicted score depend on the accuracy of the goal's actual location on the field (X, Y coordinates), the actual time of the match, and the actual identity of the player who scored the goal.

According to one aspect, the reward calculation module 212 is configured to minimize fraudulent or malicious gaming activity by applying a multiplier to the reward amount based on the accuracy of predicted macro-outcomes. A malicious user may attempt to game or trick the event prediction system by predicting a high number of macro-outcomes and corresponding micro-outcomes for a particular event. For example, assume that a first user predicts a final score of 100-100 for a particular soccer match and predicts a corresponding player identity, location, and time for each of the goals. Also, assume that a second user predicts a final score of 1-1 for the same soccer match. If the final score is 2-2, the first user is more likely to correctly predict the details of actual goals due to the number of predictions. However, because the first user's overall final score prediction significantly deviates from the actual final score; the second user should receive more points than the second user. By applying a multiplier, users that are closest on overall score will receive the most points.

According to one aspect, the reward calculation module 212 calculates a multiplier based on the accuracy of the overall predicted score (i.e., macro-outcome) for the event. The reward calculation module 212 then applies the multiplier to the determined reward amount to calculate an adjusted reward amount for each user. For example, a user that has correctly predicted a final score will have a predetermined multiplier value (e.g., 50 or 100) applied to his or points calculated based on predicted micro-outcomes. As a result, a user that predicts the correct final score will have a higher multiplier and thus may have more points than another user that predicts a final score that is significantly different from the correct score, even if that other user is closer to predicting the actual micro-outcomes

As another aspect, the multiplier may be calculated based on the difference between predicted final score is to actual final score. For example, the reward calculation module 212 first calculates a difference between the predicted final score and actual final score and then queries a multiplier table (e.g., Table 1) in the data source to identify a corresponding multiplier. In this example, the table stores different predetermined multipliers that are index according to a difference values that correspond to possible differences or ranges of differences. Table 1 may identify, for example, multipliers for soccer games. However, it is contemplated that there may be different multiplier tables different games

TABLE 1

| Difference Between Predicted Final Score | | |
|---|---|---|
| and Actual Final score | | Multiplier |
| 0 | Points | 50 |
| 1-2 | Points | 25 |
| 3-4 | Points | 10 |
| 5-7 | Points | 1 |
| >7 | Points | None |

According to another aspect, the reward calculation module 212 calculates the reward amount for predicted micro-outcomes and/or multipliers based on one or more business rules stored in the data source 106. For example, the business rules may limit the reward amount based on a maximum number of goals that the user can specify.

According to another aspect, a reporting module 214 generates prediction performance data for display via a reporting form. The prediction performance data indicates the accuracy of the user's prediction performance during the event and/or after the event is completed. For example, the prediction performance data may include a percentage of predictions that matched actual outcomes during the event, a side by side comparison of predicted outcomes and actual outcomes, and/or other prediction performance data. This allows users to monitor their predictions and see how they compare to the actual outcomes statistics. FIG. 3G depicts an exemplary screen shot of a reporting form 352 generated by the reporting module 212.

According to another aspect, the reporting module 214 generates reward data for display via the reporting form 354. In this example, rewards data includes rewards amounts for each predicted micro-outcome, total reward amounts for all predicted micro-outcomes, a calculated multiplier, and/or an adjusted point total. For example, FIG. 3H depicts reward data for predictions made by a user, Bubby Whipple, for a particular event between Sporting KC and Montreal. In this example, Bubby Whipple has predicted that Kei Kamara will score the first goal at X, Y location 8, 14 at thirty three (33) minutes into the event. The reporting form 352 also displays actual micro-outcome data for the first goal. In this example, the actual micro-outcome data indicates the first goal was by Teal Bunbury at location 15, 31 and at forty-nine (49) minutes into the match.

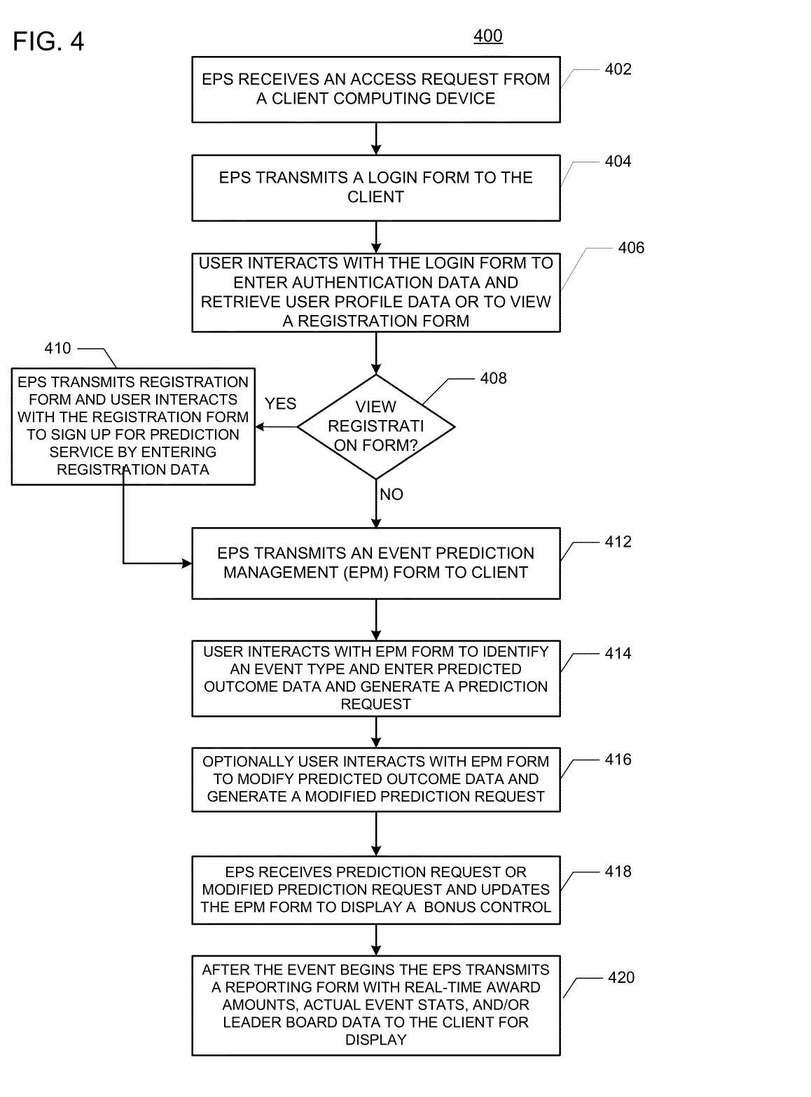

FIG. 4 illustrates a method 400 for submitting a prediction request in accordance with an aspect of the EPS 100. At 402, an access request is received at the EPS 100 from a client computing device (e.g., client 108). The EPS 100 transmits a login form to the client via a communication network at 404. The login form is a structured document, such as a hypertext document that has been coded with a markup language. At 406 the user interacts with the login form to enter authentication data or to view a registration form.

If the EPS 100 determines that the user has requested to view the registration form at 408, the EPS 100 transmits the registration form to the client via the communication network and the user interacts with the registration form to enter registration data at 410. If the EPS 100 determines that the user has entered valid authentication and, thus, does not need view the registration form at 408, the EPS 100 transmits an event prediction management form to the client via the communication network at 412.

At 414, the user interacts with the event prediction management form to enter predicted outcome data and generate a prediction request. As described above, the predicted outcome data includes micro-outcome-data and/or macro-outcome data received from a particular user. Optionally, at 416 the user interacts with the event prediction management form to modify predicted outcome data and generate a modified prediction request. The EPS 100 updates the event prediction management form to display a bonus control at 418. The bonus control enables the user to interact with slot machine like functionality and generate up to three random outcomes for which the user will be awarded a bonus amount (e.g., point or money) if one or more of the random outcomes occur.

At 420, after the event begins, the EPS 100 transmits a reporting form to the client for display. As described above, the reporting form may include reward data, predicted outcome data, and actual outcome data. According to the other aspects, the reporting form may also display reward data and/or predicted outcome data for one or more other players, such as players with most accurate predictions and/or highest reward amounts.

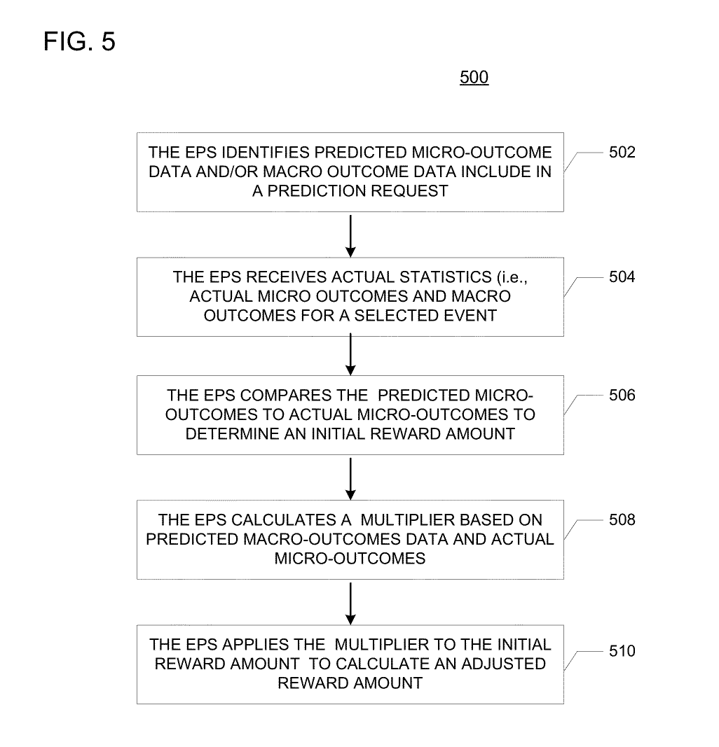

FIG. 5 illustrates a method 500 for calculating and award amount for a prediction request in accordance with an aspect of the EPS 100. At 502, the EPS 100 identifies the predicted micro-outcome data and the EPS 100 macro-outcome data included in a received prediction request related to a particular event. The EPS 100 receives actual micro-outcomes, macro-outcomes, and/or other statistics for the particular even at 504. At 506, the EPS compares the predicted micro-outcomes to actual micro-outcomes for he particular event and determines an initial reward amount based on accuracy. The EPS calculates a multiplier based on a comparison of the predicted macro-outcomes to the actual macro-outcomes at 508. At 510, the EPS multiplies the initial reward amount by the multiplier to calculate an adjusted reward amount.

Those skilled in the art will appreciate that variations from the specific embodiments disclosed above are contemplated by the invention. The invention should not be restricted to the above embodiments, but should be measured by the following claims.

What is claimed is:

1. A system for predicting at least one outcome of an event comprising:
at least one processor;
an application comprising modules executable by the at least one processor, the modules comprising:
a graphical user interface module to transmit a graphical user interface for the display, wherein the graphical user interface is configured to:
receive one or more inputs defining predicted micro-outcome data for a particular event, the predicted micro-outcome data comprising a particular player identity associated with a particular micro-outcome during the particular event, a particular location within a venue for the particular micro-outcome; and a particular time during the particular event the particular micro-outcome occurs; and
generate a prediction request comprising the predicted micro-outcome data;
a prediction processing module to:
receive the prediction request;
retrieve actual micro-outcome data from an actual outcome data source;
a reward calculation module to calculate a reward amount based on a comparison of the actual micro-outcome data with the predicted micro-outcome data included in the prediction request.

2. The system of claim 1 wherein the reward amount comprises at least one of a number of point and a monetary amount:

3. The system of claim 1 wherein the graphical user interface enables a user to designate whether the reward amount is the number of points or the monetary amount,

4. The system of claim 1 wherein:
the prediction processing module:
determines predicted macro-outcome data for the particular event based on the predicted micro-outcome data for that particular event; and
retrieve actual micro-outcome data from the actual outcome data source; and
the reward calculation module:
calculates a multiplier based on a comparison of the actual macro-outcome data with the predicted macro-outcome data and one or more business rules; and
applies the multiplier to the reward amount to calculate an adjusted reward amount.

5. A system for predicting at least one outcome of an event comprising:
at least one processor;
a memory storing venue data for a plurality of events, wherein the venue data comprises a graphical view of a venue for each of the plurality of events;
a prediction application comprising modules executable by the at least one processor, the modules comprising:
a graphical user interface module to transmit a graphical user interface for display, wherein the graphical user interface is configured to:
display a list of events;
receive a first input corresponding to a selection of a particular event from the list of events;
display a list of outcome types for the particular event selected;
receive a second input corresponding to a selection of a particular outcome type from the list of outcome types;
display corresponding venue data for the particular event selected;
display a first plurality of tokens associated with a first team competing in the particular event;
display a second plurality of tokens associated with a second team competing in the particular event;
receive at least one third input each comprising position data for a particular one of the tokens selected from the first plurality of tokens and the second plurality of tokens, the position data indicating a particular location on the graphical view for an occurrence of the particular outcome type;
display a list of eligible player identities based on the position data for the particular token;
receive a fourth input corresponding to a particular player identity predicted to be involved with the selected outcome type;
generate a prediction request comprising predicted outcome data, the predicted outcome data comprising the particular player identity and the particular location for the particular outcome type;
a prediction processing module to:
receive the prediction request;
retrieve actual outcome data from an actual outcome data source, the actual outcome data comprising at least an actual player identification and an actual location for each actual outcome type occurring during the particular even; and
a reward calculation module to calculate a reward amount for the prediction request based on a comparison of the actual outcome data with the predicted outcome data included in the prediction request.

6. The system of claim 5 wherein:
the graphical user interface is further configured to receive a fifth input comprising time data, the time data indicating a particular time for the outcome to occur during the particular event;
the predicted outcome data further comprises the particular time; and
the actual outcome data further comprises an actual time of the particular outcome

7. The system of claim 5 wherein the reward amount comprises at least one of a number of point and a monetary amount:

8. The system of claim 5 wherein:
the graphical user interface enables a user to designate whether the reward amount is the number of points or the monetary amount; and
the reward calculation module transfers the reward amount to the user associated with the prediction request.

9. The system of claim 5 wherein the at least one third input corresponds to a drag and drop operation of the particular one of the tokens to the particular location on the graphical view.

10. The system of claim 5 wherein:
the predicted outcome data comprises predicted micro-outcome data and predicted macro-outcome data; and
the actual outcome data comprises actual micro-outcome and actual macro-outcome data.

11. The system of claim 10 wherein the reward calculation module calculates an initial reward amount based on a comparison of the actual micro-outcome data with the predicted micro-outcome data.

12. The system of claim 11 wherein the reward calculation module is further configured to:
calculate a multiplier based on a comparison of the actual macro-outcome data with the predicted macro-outcome data and one or more business rules; and
calculate an adjusted reward amount by applying the multiplier to the award amount.

13. A method for predicting at least one outcome of an event, the method comprising:
transmitting a graphical user interface for the display, wherein the graphical user interface is configured to:
receive one or more inputs defining predicted micro-outcome data for a particular event, the predicted micro-outcome data comprising a particular player identity associated with a particular micro-outcome during the particular event, a particular location within a venue for the particular micro-outcome; and a particular time during the particular event the particular micro-outcome occurs; and
generate a prediction request comprising the predicted micro-outcome data;
receiving the prediction request at a processor;
retrieving actual micro-outcome data from an actual outcome data source;
calculating a reward amount based on a comparison of the actual micro-outcome data with the predicted micro-outcome data included in the prediction request;

14. A method for predicting at least one outcome of an event, the method comprising:
receiving a prediction request comprising predicted micro-outcome data at at least one processor, the predicted micro-outcome data comprising a particular player identity associated with a particular micro-outcome during a particular event, a particular location within a venue for the particular micro-outcome; and a particular time during the particular event the particular micro-outcome occurs;
retrieving actual micro-outcome data from an actual outcome data source for the particular event;
calculating, at the at least one processor, an reward amount based on a comparison of the actual micro-outcome data with the predicted micro-outcome data included in the prediction request; and
transferring the reward amount to an account associated with a particular user associated with the prediction request.

15. The method of claim 14 wherein the reward amount comprises at least one of a number of point and a monetary amount.

16. The method of claim 15 further comprising transmitting the graphical user interface for display at a remote computing device, wherein the graphical user interface is configured to receive one or more inputs defining the predicted micro-outcome data for the particular event.

17. The method of claim 16 wherein the graphical user interface enables a user to designate whether the reward amount is the number of points or the monetary amount.

18. The method of claim 14 further comprising:
determining, at the at least one processor, predicted macro-outcome data for the particular event based on the predicted micro-outcome data included in the prediction request for that particular event; and
retrieving actual macro-outcome data from the actual outcome data source; and
calculating, at the at least one processor, a multiplier based on a comparison of the actual macro-outcome data with the predicted macro-outcome data and one or more business rules; and
calculating, at the at least one processor, an adjusted reward amount by applying the multiplier to the reward amount.

19. A method for predicting at least one outcome of an event comprising:
storing venue data for a plurality of events in a memory, wherein the venue data comprises a graphical view of a venue for each of the plurality of events;
transmitting a graphical user interface for the display at a remote computing device, wherein the graphical user interface is configured to:
display a list of events;
receive a first input corresponding to a selection of a particular event from the list of events;
display a list of outcome types for the particular event selected;
receive a second input corresponding to a selection of a particular outcome type from the list of outcome types;
display corresponding venue data for the particular event selected;
display a first plurality of tokens associated with a first team competing in the particular event;
display a second plurality of tokens associated with a second team competing in the particular event;
receive at least one third input each comprising position data for a particular one of the tokens selected from the first plurality of tokens and the second plurality of tokens, the position data indicating a particular location on the graphical view for an occurrence of the particular outcome type;
display a list of eligible player identities based on the position data for the particular token;
receive a fourth input corresponding to a particular player identity predicted to be involved with the selected outcome type;
receive a prediction request generated at a processor in response to one or more inputs received at the graphical user interface, the prediction request comprising predicted outcome data, the predicted outcome data comprising the particular player identity and the particular location for the particular outcome type;
retrieving actual outcome data from an actual outcome data source, the actual outcome data comprising at least an actual player identification and an actual location for each actual outcome type occurring during the particular even; and
calculating a reward amount at the processor based on a comparison of the actual outcome data with the predicted outcome data included in the prediction request.

20. The method of claim 19 wherein:
the predicted outcome data comprises predicted micro-outcome data and predicted macro-outcome data; and
the actual outcome data comprises actual micro-outcome and actual macro-outcome data; and
the method further comprising:
determining, at the at least one processor, predicted macro-outcome data for the particular event based on the predicted micro-outcome data included in the prediction request for that particular event;
retrieving actual macro-outcome data from the actual outcome data source;
calculating, at the at least one processor, a multiplier based on a comparison of the actual macro-outcome data with the predicted macro-outcome data and one or more business rules; and
calculating, at the at least one processor, an adjusted reward amount by applying the multiplier to the reward amount.
